(19) United States
(12) Patent Application Publication
(10) Pub. No.: US 2008/0004108 A1
(43) Pub. Date: Jan. 3, 2008

(54) Gaming Device Supplementing a Table Roulette Game

(75) Inventor: Otmar Klinkhammer, Konz (DE)

Correspondence Address: PATENT LAW GROUP LLP, 2635 NORTH FIRST STREET, SUITE 223, SAN JOSE, CA, 95134, US

(73) Assignee: ATRONIC INTERNATIONAL GMBH, Lubbecke (DE)

(21) Appl. No.: 11/763,932

(22) Filed: Jun. 15, 2007

(30) Foreign Application Priority Data
Jun. 28, 2006 (DE) 20 2006 010 128.4

(51) Int. Cl. A63F 13/12

(52) U.S. Cl. 463/29; 463/17; 463/42

(57) ABSTRACT

A supplementary gambling game allows a player to participate in a physical table game without having to sit at the table and bet on every outcome. The game does not require any additional casino operator. In one embodiment of the game, an existing roulette table game is the source of a set of random numbers used in the supplementary game. The conventional roulette game played at the roulette table is unaffected by the new game. A player playing the supplementary game uses a game terminal to bet and select a set of numbers applicable starting at a certain time. The terminal issues a ticket with the relevant information. The random numbers generated in the actual table game are transmitted to the terminal and are later compared to the player's selected numbers. An award is granted to the player based upon the matching of the numbers.

### FIELD OF INVENTION

This invention relates to gaming and, in particular, to a betting game and apparatus played in conjunction with an existing conventional roulette game or other game that randomly selects numbers.

### BACKGROUND

In a casino, there are many type of gambling games, such as slot machines, roulette, keno, card games, and dice games (e.g., craps). The non-slot machine games are generally referred to as table games, and an attendant, operator, or dealer must be paid by the casino to operate those games. Some players may feel intimidated by playing at a table with others or do not want the financial pressure of having to bet on every outcome of the table game. Further, some players do not want to be committed to a particular game table by sitting at the table. Accordingly, the table games do not derive any income from those players.

These types of players would be interested in a low-pressure, simple betting game, other than a slot machine game, that does not require playing at a game table. Casinos are interested in new games that do not incur significant overhead, such as the cost for paying a dedicated operator of the game.

### SUMMARY

A new gambling game and apparatus are described herein that allows a player to participate in a table game without having to sit at the table and bet on every outcome. The game does not require any additional casino operator.

In one embodiment of the game, an existing roulette table game is the source of a set of random numbers used in the new supplementary game. The conventional roulette game played at the roulette table is unaffected by the supplementary game.

A player of the supplementary game uses a gaming terminal to initiate the game. The gaming terminal leads the player through the betting process with a series of simple selection displays. In one embodiment, the game is simply selecting a set of 10 numbers from the set of possible numbers that can be selected by a roulette wheel. The player designates a particular roulette table, a bet amount, and the 10 numbers. The terminal then prints a ticket with the starting time, the 10 numbers, the table number, and coded verification information (e.g., a bar code encrypting all the relevant information and a security code).

The player then may walk to the selected roulette table and oversee the outcomes of the spins beginning from the start time on the ticket. In one embodiment, the game compares the player's selected 10 numbers to the 15 consecutive numbers selected by the roulette wheel after the start time. The amount awarded to the player is based on how many numbers the player has matched and, optionally, the matching order of the numbers.

The game may be based on more or fewer than 10 numbers selected by the player and more or fewer than 15 numbers selected by the roulette wheel.

After the completion of the game (e.g., 15 numbers have been selected by the roulette wheel), the player inserts the ticket into the game terminal for scanning the verification code, and the game terminal determines the award to be granted to the player. The game terminal prints a redemption ticket for the player if the player wishes to cash out. The player then takes the ticket to a cashier for obtaining cash. It is also possible to cash out at the game terminal. The player may instead take the ticket to a cashier station or manually cash out at the cashier's cage.

Modern roulette wheels have sensors that electrically or optically detect the outcome of each spin, and the most recent outcomes are displayed on a panel attached to the roulette table. The casino system records and stores the data. The data is then sent to the gaming terminal. Such signals are transmitted to the game terminals along with time codes and are recorded by the game terminals. Such transmission may be via an existing network in the casino, by RF transmission, or by direct wires. Alternatively, the roulette table computer may store the information, and the information is accessed by the game terminal when needed, or the outcomes over a period of time are encoded on a printed ticket for insertion into the game terminal.

The random outcomes from other existing games in a casino may also be used if such outcomes are electronically recorded.

The invention requires no additional casino personal and gives certain types of players an opportunity to participate in a table game.

In another embodiment, the game terminal may take the form of a hand-held tablet, and the player keeps the tablet for the duration of play. In such a case, no tickets need to be printed by the tablet since the outcomes and awards are recorded by the tablet and later downloaded at a redemption terminal for payment of the awards to the player.

### BRIEF DESCRIPTION OF THE DRAWINGS

The below described drawings are presented to illustrate some possible examples of the invention.

FIG. 1 is a schematic depiction of a roulette table that conveys the wheel outcomes to a remote game terminal.

FIG. 2 illustrates the game terminal used by a player to select numbers, bet, and play the supplementary game.

FIG. 3 illustrates a hand-held tablet that may be used to play the supplementary game.

FIG. 4 is a flowchart identifying steps carried out in one embodiment of the supplementary game.

### DETAILED DESCRIPTION

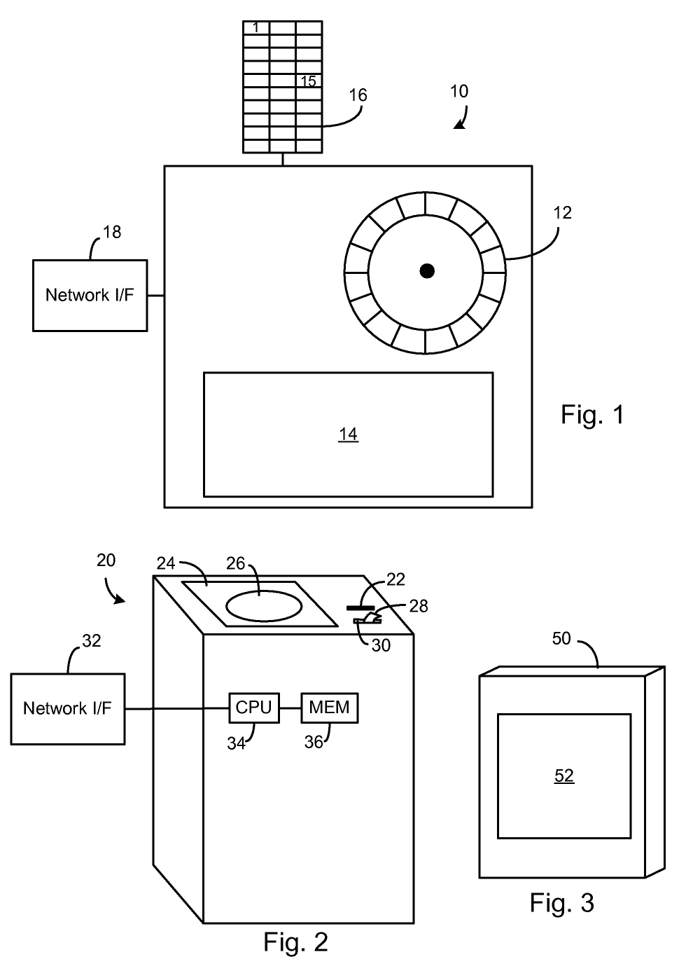

FIG. 1 illustrates a physical roulette table 10, having a conventional rotatable roulette wheel 12, a chip betting surface 14, a display 16 for displaying recent numbers selected, and a network interface 18 for transmitting the selected numbers to a remote receiver. Although portions of the roulette table are conventional, other portions, such as the network connection, may not be conventional. A first group of players sits at the roulette table 10 and plays roulette in the conventional manner.

Modern roulette wheels have an optical sensor or other type of sensor in each possible ball position that detects the outcome after each spin of the wheel. There are 38 numbers (0, 00, and 1-36) in American roulette wheels and 37 numbers in European roulette wheels. Such roulette tables are available commercially, such as from TCS John Huxley.

A CPU in the table, coupled to the sensors, generates a number code associated with each stopped ball position, and the corresponding number is then shown on the display 16 at the table. The display 16 is typically an LED display or a backlight display that displays, for example, the last 10 numbers selected by the wheel. The quantity of numbers displayed may be programmable.

The number codes are also transmitted via the network interface 18 to a central server and stored in a memory, and such numbers may be later accessed by a suitable computer addressing the appropriate memory locations. Payout and pay-in data may also be transmitted via the network if RFID betting chips are used.

Additional details about roulette tables may be found in U.S. Pat. Nos. 5,042,810 and 6,352,260, incorporated herein by reference.

As described below, the existing roulette game is supplemented by a totally different game that does not affect the conventional roulette game and does not incur any additional cost for the casino.

Certain types of players do not wish to sit at the roulette table or bet on every outcome. The below game is a simple low-pressure game that makes use of the roulette outcomes.

FIG. 2 illustrates a game terminal 20 that the player may use to play the supplementary game. The player makes a wager by inserting cash or a card (e.g., player card, debit card, etc.) into slot 22. Downloading money or credits via a player card is well known. A display screen 24 provides instructions explaining the rules of the game, and instructs the player to select the applicable roulette table number and to select 10 numbers from a virtual roulette wheel 26. The screen 24 is preferably a touch screen, so the player just touches any of the 38 positions of the roulette wheel 26 to select that number. The same number may be selected multiple times. The player accepts the selection by touching an “accept” virtual button, and a paper ticket 28 is printed containing all the relevant information. The ticket 28 is issued through slot 30.

In one embodiment, the printed ticket 28 contains the name of the game, a list of the selected numbers, the start time and date of the game, the roulette table number, the bet amount, a paytable, and a verification code. The verification code contains an encrypted code, in the form of a bar code, that uniquely identifies the ticket and the accurate betting data. This code is also stored in the game terminal or the casino network server. When the player later cashes out using the ticket 28, the terminal compares the verification code on the ticket to the stored code to make sure the ticket is valid and has not already been cashed.

The player takes the ticket 28 and typically walks to the selected roulette table to watch the next 15 selections of numbers. A synchronized clock may be displayed at the roulette tables so the player knows when the supplementary game starts. The supplementary game may start, for example, two minutes after the player is issued the ticket 28 from the terminal 20. The numbers selected at the roulette table 10 are given time stamps and transmitted to the terminal 20 in any manner, such as through the casino network (via network interface 18), via an RF transmission, or via a direct wire coupling.

In FIG. 2, a network interface 32 is shown connected to a CPU 34 and memory 36 internal to the terminal 20. The CPU 34 is programmed to carry out the game by software stored in memory 36. The CPU 34 may be an ASIC or other type of controller or multi-chip system that is programmed in any known manner. The terminal 20 may also be a client terminal, where the primary processing is performed remotely by a server.

After the 15 numbers have been selected by the roulette wheel 12, the player then inserts her ticket 28 into the game terminal ticket slot 30 for scanning, or the ticket is scanned by an external laser scanner, so that the terminal 20 can verify the ticket and determine the award to be paid to the player. The terminal 20 then prints and issues a cash-out ticket through slot 30, which is a conventional cash-out ticket used in cashless gaming (referred to as ticket-in/ticket-out). The cash-out ticket may be inserted into any slot machine or any other apparatus (including terminal 20) for obtaining credits, or the ticket may be redeemed for cash at the cashier's station. Any won credits may be used to play another game via terminal 20 without obtaining a cash-out ticket.

In another embodiment, the original ticket 28 issued by the terminal 20 is redeemable at the cashier's station if the station has means to verify the ticket 28.

In other embodiments, the player may select any amount of numbers (N) to compare with the actual roulette selected numbers (M), and the paytable may determine the award based on a percentage of numbers guessed correctly. The player-selected numbers may be compared to the same amount of numbers selected by the actual roulette wheel 12 (N=M) or compared to a greater amount of numbers selected by the actual roulette wheel 12 (N<M). An additional award may be based on the player correctly guessing the order of numbers.

Various other embodiments are possible. A progressive jackpot may be accumulated from a percentage of the bets, and one or more levels of progressive jackpots may be awarded for certain percentages of matches.

There may be a tournament mode, where many players play using the same set of roulette wheel 12 numbers at the same time. Whoever has the most number of matches wins the tournament. The tournament would be publicly announced some time before the game. The tournament may cover multiple sequential games.

In one embodiment, the game terminal 20 is located proximate to an associated roulette table, and a hard wire connection between the terminal CPU 34 and table CPU simplifies the transmission of the roulette wheel numbers to the terminal 20.

In one embodiment, the player has the option of selecting 10 numbers or allowing the terminal's computer 34 to randomly select the numbers for faster throughput.

The player may enter numbers via terminal 20 for any number of separate games, with any start times designated by the player. The player can also use the numbers from multiple roulette tables in a single game.

The roulette wheel 12 may also be automated, so no operator at all is needed to carry out the game. Such a wheel can select 3000 numbers per day.

The terminal 20 may instead be hand-held, similar to the hand-held tablet 50 of FIG. 3. The tablet 50 includes a touch screen display 52, which the player uses to enter all information. The tablet 50 may be loaded with paid credits when the player obtains the tablet 50 from a rack or other source. The display 52 is used instead of a printed ticket to show the player the selected numbers and other relevant information. The tablet 50 may have a WiFi, Bluetooth, or other short range receiver for receiving the numbers selected by the physical roulette wheel 12. Any won credits may be used to play another game. At the end of a playing session, the player takes the tablet 50 back to a redemption station, which reads the tablet's stored credits and issues the player cash or a cash-out ticket.

Although a roulette wheel 12 is the preferred device for generating the numbers, the numbers may also be generated by any other ongoing game that is independent of the supplementary game and transmitted to the game terminal 20. Such game may be craps (if the dice outcomes are recorded), cards (where the suit and rank of a certain dealer's cards are the random numbers), or keno (the keno RNG transmits the numbers to the game terminal 201). A device may read the dealt cards using an RFID sensor that reads RFID chips embedded in the cards and transmits the cards to the game terminal. For dice, the outcomes may be entered by the dice table attendant, or the dice outcomes may be electrically sensed by the table.

The term numbers used herein may refer to any type of symbol. The supplementary game programmer is free to create any rules and awards based on the random numbers selected during the table game (e.g., roulette), which can make the supplementary game much more interesting than the table game.

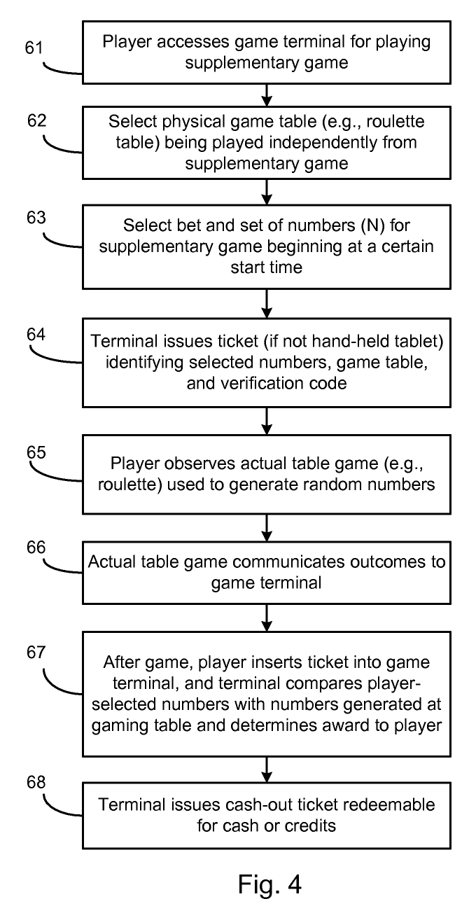

FIG. 4 is a self-explanatory flowchart summarizing various steps 61-68 described above in one embodiment of the invention.

While particular embodiments of the present invention have been shown and described, it will be obvious to those skill in the art that changes and modifications may be made without departing from this invention in its broader aspects and, therefore, the appended claims are to encompass within their scope all changes and modifications that fall within the true spirit and scope of the invention.

What is claimed is:

1. A gaming system comprising:
a first gaming apparatus in a casino, where an ongoing series of symbols is randomly generated by the first gaming apparatus during a conventional first type of game played by or more first players;
a game terminal configured for playing a second type of game by a second player, the game terminal receiving from the first gaming apparatus at least a subset of the ongoing series of symbols randomly generated using the first gaming apparatus,
the game terminal having a player interface for receiving instructions from the second player designating a bet and designating a set of symbols that can be possibly generated during the first type of game over a period of time; and
a controller programmed for comparing the set of symbols designated by the second player to a series of symbols randomly generated during the first type of game after a start time, and identifying an award to the second player based upon results of the comparing,
wherein the second type of game and first type of game are played independently of one another and have different rules of play.

2. The system of claim 1 wherein the first type of game is roulette, and the first gaming apparatus is a roulette wheel.

3. The system of claim 1 wherein the symbols are numbers.

4. The system of claim 1 wherein the set of symbols designated by the second player are individually selected by the second player.

5. The system of claim 1 wherein the set of symbols designated by the second player are randomly determined by the controller with the approval of the second player.

6. The system of claim 1 wherein no attendant is involved in carrying out the second type of game.

7. The system of claim 1 wherein a number of symbols in the set of symbols is greater than a number of symbols generated in the first type of game that are compared to the set of symbols for determining the award.

8. The system of claim 1 wherein the first gaming apparatus communicates the series of symbols to the game terminal by one of a network, an RF transmission, and a direct wire.

9. The system of claim 1 wherein the award is based on an order of the set of symbols designated by the player matching an order of the series of symbols generated in the first type of game.

10. The system of claim 1 wherein the game terminal sets a start time of the second type of game after which the series of symbols generated in the first type of game is relevant to the second type of game.

11. The system of claim 1 wherein the player interface also receives a designation by the second player identifying a particular first game apparatus out of a plurality of substantially identical first game apparatuses.

12. The system of claim 1 wherein the game terminal is a hand-held tablet.

13. The system of claim 1 further comprising a printer in the game terminal for printing out on a ticket the set of symbols designated by the second player and other information used to automatically determine relevant parameters of the second type of game.

14. The system of claim 1 wherein the first game apparatus comprises playing cards and a device conveying identities of dealt cards to the game terminal.

15. The system of claim 1 wherein the first game apparatus comprises dice and a device conveying outcomes of dice throws to the game terminal.

16. The system of claim 1 wherein the first game apparatus comprises a keno number selector.

17. The system of claim 1 wherein the first type of game is a table game.

18. A method performed by a gaming system comprising:
randomly generating an ongoing series of symbols by a first gaming apparatus in a casino during a conventional first type of game played by one or more first players;
playing a second type of game, via a game terminal, by a second player;
the game terminal receiving at least a subset of the ongoing series of symbols randomly generated by the first gaming apparatus;
the game terminal receiving instructions, via a player interface, from the second player designating a bet and designating a set of symbols that can be possibly generated during the first type of game over a period of time; and
a controller comparing the set of symbols designated by the second player to a series of symbols randomly generated during the first type of game, and identifying an award to the second player based upon results of the comparing,
wherein the second type of game and first type of game are played independently of one another and have different rules of play.

19. The method of claim 18 wherein the first type of game is roulette, and the first gaming apparatus is a roulette wheel.

20. The method of claim 18 wherein the symbols are numbers.

21. The system of claim 18 wherein the set of symbols designated by the second player are individually selected by the second player.

22. The method of claim 18 wherein the set of symbols designated by the second player are randomly determined by the controller with the approval of the second player.

23. The method of claim 18 wherein a number of symbols in the set of symbols is greater than a number of symbols generated in the first type of game that are compared to the set of symbols for determining the award.

24. The method of claim 18 wherein the first gaming apparatus communicates the series of symbols to the game terminal by one of a network, an RF transmission, and a direct wire.

25. The method of claim 18 wherein the award is based on an order of the set of symbols designated by the player matching an order of the series of symbols generated in the first type of game.

26. The method of claim 18 wherein the game terminal sets a start time of the second type of game after which the series of symbols generated in the first type of game is relevant to the second type of game.

27. The method of claim 18 further comprising printing by the game terminal a ticket identifying the set of symbols designated by the second player and other information used to automatically determine relevant parameters of the second type of game.
